(19) United States
(12) Patent Application Publication
(10) Pub. No.: US 2026/0213856 A1
(43) Pub. Date: Jul. 23, 2026

(54) METHOD OF TRANSMITTING SIGNAL AND APPARATUS THEREOF

(71) Applicant: AGENCY FOR DEFENSE DEVELOPMENT, Daejeon (KR)

(72) Inventors: In Soo KIM, Daejeon (KR); Hyung Moon KIM, Daejeon (KR); Wan Jin KIM, Daejeon (KR); Geun Ho PARK, Daejeon (KR); Jong Min AN, Daejeon (KR); Dong Hun LEE, Daejeon (KR); Sang Kuk LEE, Daejeon (KR)

(21) Appl. No.: 19/077,259

(22) Filed: Mar. 12, 2025

(30) Foreign Application Priority Data
Jan. 17, 2025 (KR) 10-2025-0007490

(51) Int. Cl. H04B 11/00; H04B 13/02; H04R 3/00

(52) U.S. Cl. CPC H04B 11/00; H04B 13/02; H04R 3/00

(57) ABSTRACT

Provided are systems, devices, methods, and instructions for transmitting an acoustic signal in an underwater environment, including receiving a signal, amplifying the signal based on a power amplifier, and transmitting underwater, based on a transducer, an acoustic signal to which the amplified signal is converted, wherein the power amplifier includes an analog to digital converter (ADC), an inverter connected to the ADC and to a load including the transducer, and a direct current (DC) link connected to the inverter.

### PRIORITY INFORMATION

This application claims the benefit of Korean Patent Application No. 10-2025-0007490, filed on Jan. 17, 2025, in the Korean Intellectual Property Office, which is hereby incorporated by reference in its entirety.

### FIELD OF THE INVENTION

The example embodiments generally relate to systems, devices, methods, and instructions for transmitting an acoustic signal in an underwater environment, and more particularly, to systems, devices, methods, and instructions for transmitting an acoustic signal in an underwater environment based on a power amplifier including a direct current (DC) link.

### DESCRIPTION OF THE RELATED ART

Sound is one of the physical options for transferring signals in underwater environments. Since sound may effectively transfer signals in underwater environments, underwater communications may be carried out based on sound. In this process, a high-power amplifier that amplifies the signals may be required.

In a current method of amplifying a signal, a distortion of a magnitude and a phase of a signal transfer function may occur due to a filter and a transformer within a power amplifier. In transmitting a signal for underwater detection, a frequency of the signal and a magnitude of the signal may be only considered, but in transmitting a signal for underwater communications, a phase response characteristic of the signal may also need to be considered, in addition to a frequency of the signal and a magnitude of the signal. However, even though the filter within the power amplifier is designed appropriately, a distortion of a transfer function may occur if a connected load has a nonlinear device characteristic.

Therefore, the embodiments of the present invention provide systems, devices (i.e., an electronic apparatus), methods and instructions for transmitting an acoustic signal in an underwater environment based on a power amplifier including a DC link.

### SUMMARY

Accordingly, the embodiments of the present invention substantially obviate one or more problems due to limitations and disadvantages of the related art.

An aspect provides an electronic apparatus that transmits an acoustic signal in an underwater environment based on a power amplifier including a DC link.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

According to an example embodiment, there is provided a method of transmitting an acoustic signal in an underwater environment by an electronic apparatus, the method including receiving a signal, amplifying the signal based on a power amplifier, and transmitting underwater, based on a transducer, an acoustic signal to which the amplified signal is converted, and the power amplifier includes an analog to digital converter (ADC), an inverter connected to the ADC and to a load including the transducer, and a direct current (DC) link connected to the inverter.

According to an example embodiment, the ADC may include a first conversion part and a second conversion part, each connected to the inverter.

According to an example embodiment, a magnitude of the signal may be converted to a binary bit corresponding to the magnitude of the signal based on the first conversion part and transferred to the inverter, and a sign of the signal may be converted to a binary bit corresponding to the sign of the signal based on the second conversion part and transferred to the inverter.

According to an example embodiment, the DC link may include one or more DC voltage sources, and a number of the one or more DC voltage sources may be determined to correspond to a bit number of the binary bit corresponding to the magnitude of the signal.

According to an example embodiment, a voltage value of each DC voltage source included in the one or more DC voltage sources may be set based on an exponential gap.

According to an example embodiment, the inverter may include one or more switching circuits, and information on each bit of the binary bit corresponding to the magnitude of the signal and information on a voltage of each DC voltage source included in the one or more DC voltage sources may be transferred to each switching circuit included in the one or more switching circuits.

According to an example embodiment, the magnitude of the signal may be amplified based on the DC link through the one or more switching circuits.

According to an example embodiment, the amplified signal may be obtained from the inverter based on the amplified magnitude and information on the binary bit corresponding to the sign of the signal, and the amplified signal may be transferred to the load including the transducer.

According to an example embodiment, the transducer may include a sensor connected to a matching device to which the amplified signal is inputted and configured to convert the amplified signal to the acoustic signal and transmit the acoustic signal.

According to another aspect, there is provided an electronic apparatus that performs a method of transmitting an acoustic signal in an underwater environment, the electronic apparatus including a processor and one or more memories configured to store one or more instructions, and when executed, the one or more instructions are configured to control the processor so that the processor performs receiving a signal, amplifying the signal based on a power amplifier, and transmitting underwater, based on a transducer, an acoustic signal to which the amplified signal is converted, and the power amplifier includes an analog to digital converter (ADC), an inverter connected to the ADC and to a load including the transducer, and a direct current (DC) link connected to the inverter.

Various example embodiments of the present disclosure described above are merely some of the example embodiments of the present disclosure, and other example embodiments that reflect technical features of various example embodiments of the present disclosure may be inferred and understood based on the following detailed description by a person of ordinary skill in the art.

According to example embodiments, a signal may be amplified without a filter and a transformer.

In addition, according to example embodiments, a constant transfer characteristic may be provided irrespective of features of a sensor included in a transducer.

Further, according to example embodiments, it is feasible to amplify higher or adjust more precisely a voltage based on the numbers of DC links and switching circuits.

Effects of example embodiments are not limited to those described above, and other unstated effects may be apparent to those of ordinary skill in the art to which the present disclosure pertains from the following description. It is to be understood that both the foregoing general description and the following detailed description are examples and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates an electronic apparatus according to an example embodiment;

FIG. 2 illustrates an existing structure of underwater acoustic transmission;

FIG. 3 illustrates a signal transfer characteristic of an existing power amplifier;

FIG. 4 illustrates a change of a voltage transfer characteristic based on a load in an existing structure of underwater acoustic transmission;

FIG. 5 illustrates a structure of underwater acoustic transmission according to an example embodiment;

FIG. 6 is a circuit diagram of a power amplifier according to an example embodiment;

FIGS. 7A and 7B illustrate a signal transfer characteristic of an existing power amplifier;

FIGS. 8A and 8B illustrate a signal transfer characteristic of a power amplifier according to an example embodiment of the present disclosure; and

FIG. 9 illustrates a flowchart of a method of transmitting a signal by an electronic apparatus according to an example embodiment.

### DETAILED DESCRIPTION

Reference will now be made in detail to the embodiments of the present invention, examples of which are illustrated in the accompanying drawings.

The example embodiments described below are combinations of elements and characteristics of various example embodiments in a predetermined form. Each element or characteristic may be optional unless clearly otherwise stated. Each element or characteristic may be implemented in a form not combined with another element or characteristic. In addition, some elements and characteristics may also be combined to form various example embodiments. An order of operations described in various example embodiments may be changed. Some elements or characteristics of one example embodiment may be included in another example embodiment or may be replaced with a corresponding element or characteristic of another example embodiment.

In descriptions of the drawings, a process, an operation, or the like that may obscure the gist of various example embodiments is not described, and a process or an operation that may be understood by a person of ordinary skill in the art is also not described.

Throughout the specification, when a part is described as “comprising or including” a component, it does not exclude another component but may further include another component unless otherwise stated. Furthermore, terms such as “. . . part,” “. . .-or,” and “. . . module” described in the specification mean a unit that processes at least one function or operation, which may be implemented as hardware, software, or a combination thereof. In addition, “a or an,” “one,” “the,” and similar words may be used as including both singular and plural meanings unless otherwise indicated in this specification or clearly contradicted contextually in the context of describing various example embodiments (in particular, the context of the claims).

Hereinafter, various example embodiments are described in detail with reference to the accompanying drawings. The following detailed description with reference to the accompanying drawings is to describe various example embodiments and not to indicate the only embodiment.

In addition, specific terms used in various example embodiments are provided to help the understanding of various example embodiments, and the usage of these terms may be changed into other forms within the scope of the technical idea of various example embodiments.

Since sound may effectively transfer a signal in the underwater environment, underwater communications may be carried out based on the sound. A process of applying a power signal with high voltage to an acoustic transmission sensor included in a transducer and converting the signal to an acoustic signal may be required to transmit the acoustic signal underwater. In this process, a high-power amplifier that may amplify the signal may be required.

An existing method of amplifying a signal is carried out based on a Class-D amplifier with a pulse width modulation (PWM) manner, and thus, a filter and a transformer for voltage conversion are present within a power amplifier. The Class-D amplifier with the PWM manner may also be referred to as a digital amplifier or a switching amplifier and may amplify an inputted signal based on the PWM manner. According to the PWM manner, an analog signal may be converted to a fast switching signal, and accordingly, power may be efficiently amplified. For example, an analog input signal may be converted into a digital form and then modulated into a PWM signal. The PWM signal may output a switching signal, which is a high-frequency pulse signal, by controlling a power supply of a switching device (for example, a metal-oxide-semiconductor field-effect transistor (MOSFET) or an insulated gate bipolar transistor (IGBT)), and the outputted switching signal may be converted to an analog audio signal through filtering.

However, in the existing method of amplifying the signal, a distortion of a magnitude and a phase of a signal transfer function may occur due to the filter and the transformer within the power amplifier. Even though the filter within the power amplifier is designed appropriately, a distortion of a transfer function may occur if a connected load has a nonlinear device characteristic.

Therefore, the present disclosure provides systems, devices, methods, and instructions for transmitting an acoustic signal without a distortion of a transfer characteristic in an underwater environment based on a power amplifier including a direct current (DC) link, instead of an existing power amplifier including an LC filter and a transformer.

A method of transmitting a signal according to the present disclosure may also be effectively applied to a communication system in the field of national defense to transmit defense classified information with no distortion in the underwater environment. As an example, in the communication system of the field of national defense, national security classified information may be transmitted and such information may also be transmitted through the underwater environment according to cases, and thus, in the communication system of the field of national defense, information may need to be transmitted with no distortion even in the underwater environment, irrespective of a load connected to the system. In response to such characteristic in the field of national defense, the method of transmitting the signal described below according to the present disclosure may enable a signal to be transmitted with no issue even in the underwater environment by amplifying and converting the signal based on a power amplifier including a DC link instead of a LC filter and a transformer, and thus, may be understood as corresponding to the technical idea that may be easily applied to various communication systems for the military.

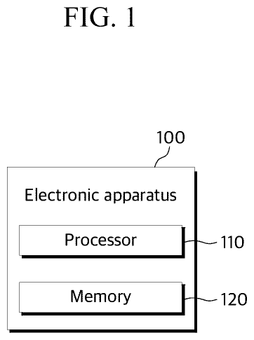

FIG. 1 illustrates an electronic apparatus according to an example embodiment. A

Referring to FIG. 1, an electronic apparatus 100 may include a processor 110 and a memory 120. In the electronic apparatus 100 illustrated in FIG. 1, elements related to the example embodiments are illustrated. Therefore, it may be understood by those of ordinary skill in the art to which the example embodiments pertain that other general-purpose elements may be further included in addition to the elements illustrated in FIG. 1. For example, the electronic apparatus 100 may include a communication device including one or more transceivers, an input part, and an output part. The communication device may be a device for performing wired and wireless communications and may communicate with an external electronic device. The external electronic device may be a terminal or a server. In addition, a communication technology used by the communication device may include a global system for mobile communication (GSM), code division multi-access (CDMA), long term evolution (LTE), 5G, wireless local area network (WLAN), wireless-fidelity (Wi-Fi), Bluetooth, radio frequency identification (RFID), infrared data association (IrDA), ZigBee, near field communication (NFC), and the like. The input part may be, for example, a keypad or a keyboard of a traditional form, a mouse, a microphone to which a voice signal is inputted, a camera, and other various forms of input options that sense or receive various forms of user inputs. The output part may be, for example, a display that outputs a video, and a speaker that outputs a sound, a haptic device that generates vibrations, and other various forms of output options.

The electronic apparatus 100 of FIG. 1 may receive a signal. The electronic apparatus 100 may amplify the signal based on a power amplifier. The electronic apparatus 100 may transmit underwater, based on a transducer, an acoustic signal to which the amplified signal is converted.

The processor 110 may perform a role of controlling overall functions of the electronic apparatus 100. For example, the processor 110 may control the electronic apparatus 100 in general by executing programs stored in the memory 120 within the electronic apparatus 100. The processor 110 may be implemented as a central processing unit (CPU), a graphics processing unit (GPU), or an application processor (AP) provided within the electronic apparatus 100 but is not limited thereto.

The memory 120 may be hardware for storing a variety of data processed in the electronic apparatus 100, and the memory 120 may store data processed in the electronic apparatus 100 and data to be processed therein. In addition, the memory 120 may store applications, drivers, or the like to be operated by the electronic apparatus 100. The memory 120 may include random access memory (RAM), such as dynamic random access memory (DRAM) and static random access memory (SRAM), read-only memory (ROM), electrically erasable programmable read-only memory (EEPROM), CD-ROM, Blu-ray or other optical disk storage, hard disk drive (HDD), solid-state drive (SSD), or flash memory.

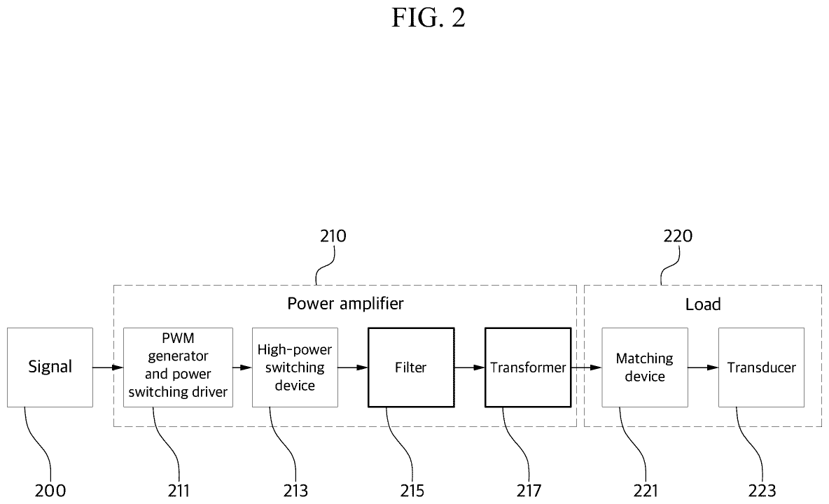

FIG. 2 illustrates an existing structure of underwater acoustic transmission.

Referring to FIG. 2, the existing structure of underwater acoustic transmission may receive a signal 200, amplify the received signal 200 through a power amplifier 210, and convert the amplified signal 200 to an acoustic signal through a transducer of a load 220.

The existing power amplifier 210 may include a PWM generator and power switching driver 211, a high-power switching device 213, a filter 215, and a transformer 217. The PWM generator and power switching driver 211 may process, in the PWM manner, and convert the inputted signal 200 to a digital pulse and provide a voltage for controlling a switching device based on a PWM signal. The high-power switching device 213 may amplify the signal 200 by controlling current and voltage. The filter 215 may be a filter including a nonlinear device and may improve a quality of an output signal and remove an unnecessary high-frequency component. The filter 215 may include a low pass filter (LPF). The transformer 217 may adjust an output voltage of the power amplifier to a demand voltage of the load 220 and perform impedance matching between the power amplifier 210 and the load 220.

The load 220 may include a matching device 221 and a transducer 223. The load 220 may correspond to a load connected to a power amplifier of the present disclosure. The load 220 may include a speaker. The matching device 221 may perform matching between the impedance of the power amplifier 210 and the impedance of the load 220 and transfer optimum power to the transducer 223. The transducer 223 may correspond to an energy conversion device that converts an electrical signal to an acoustic signal. The transducer 223 may include an acoustic sensor. When a signal after amplified is inputted to the matching device 221, the acoustic sensor connected to the matching device 221 may convert the amplified signal to an acoustic signal and transmit the acoustic signal.

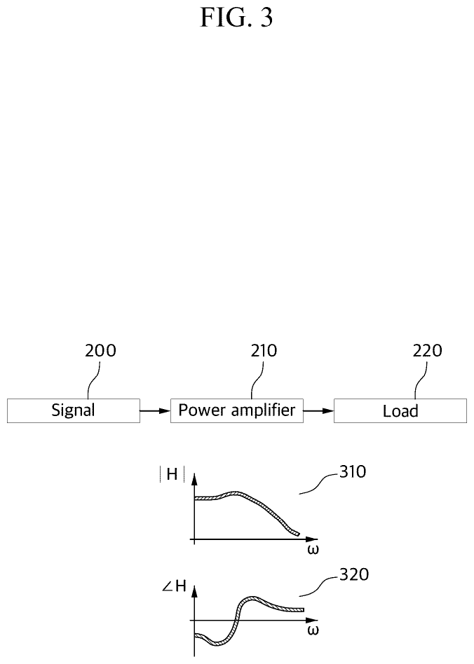

FIG. 3 illustrates a signal transfer characteristic of an existing power amplifier.

Referring to FIG. 3, the existing power amplifier 210 may generate a distortion of a magnitude and a phase of a transfer function of the signal 200 due to the filter 215 and the transformer 217 therewithin. Referring to a graph 310 indicating a magnitude change of the transfer function based on a frequency change and a graph 320 indicating a phase change of the transfer function based on the frequency change, it may be identified that the magnitude or the phase of the transfer function of the signal 200 is not maintained at a predetermined level and is distorted based on frequency.

This distortion of the transfer function may cause difficulty in transmitting a signal for underwater communications, where response characteristics of the magnitude, the frequency, and the phase of the signal 200 are all considered.

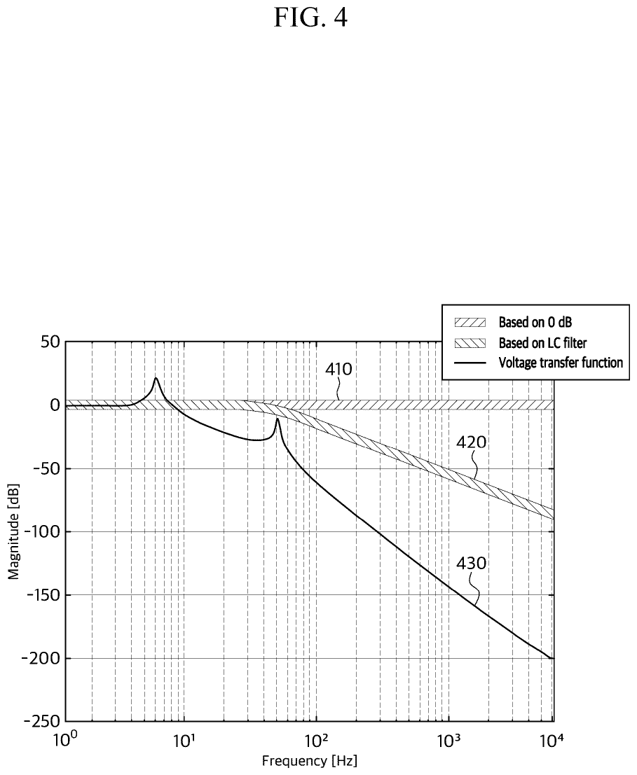

FIG. 4 illustrates a change of a voltage transfer characteristic based on a load in an existing structure of underwater acoustic transmission.

Referring to FIG. 4, even though the filter 215 within the existing power amplifier 210 is designed appropriately, a distortion of a transfer function may occur if the connected load 220 has a nonlinear device characteristic.

FIG. 4 shows a magnitude change of a voltage transfer function based on a frequency change, and if the filter 215 is not present within the power amplifier 210, a transfer function may be represented as a graph 410. Compared thereto, if the filter 215 is present within the power amplifier 210, a transfer function based on the filter 215 may be designed as a graph 420, but if the load 220 having an unexpected nonlinear characteristic such as the occurrence of resonance is connected to the power amplifier 210, a voltage transfer function may be distorted as a graph 430. When resonance occurs in a specific frequency and a transfer function is distorted as above, it may be difficult to transfer a signal with a magnitude constant.

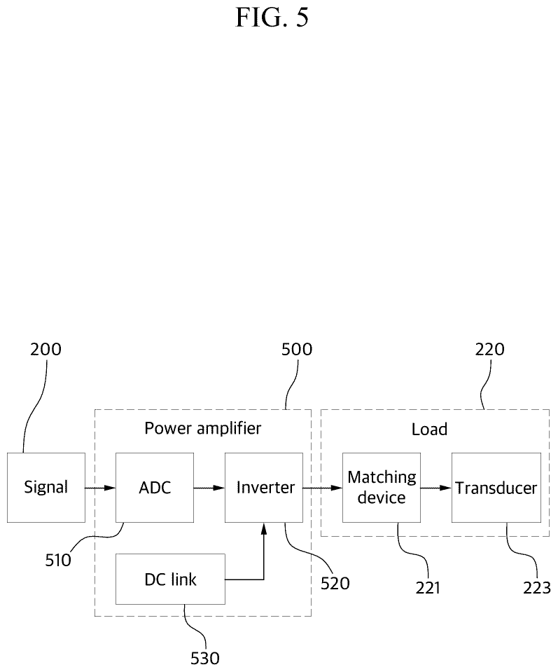

FIG. 5 illustrates a structure of underwater acoustic transmission according to an example embodiment.

Referring to FIG. 5, the electronic apparatus 100 may receive the signal 200, amplify the received signal 200 through a power amplifier 500, and convert the amplified signal 200 to an acoustic signal through the transducer 223 of the load 220 and transmit the acoustic signal.

According to an example embodiment, the power amplifier 500 may include an analog to digital converter (ADC) 510, an inverter 520 connected to the ADC 510 and configured to output the amplified signal 200 to the load 220, and a direct current (DC) link 530 connected to the inverter 520. According to FIG. 5, the amplified signal 200, which is outputted from the inverter 520, may be transferred to the transducer 223, and therefore, it may be understood that the inverter 520 and the transducer 223 may also be connected to each other.

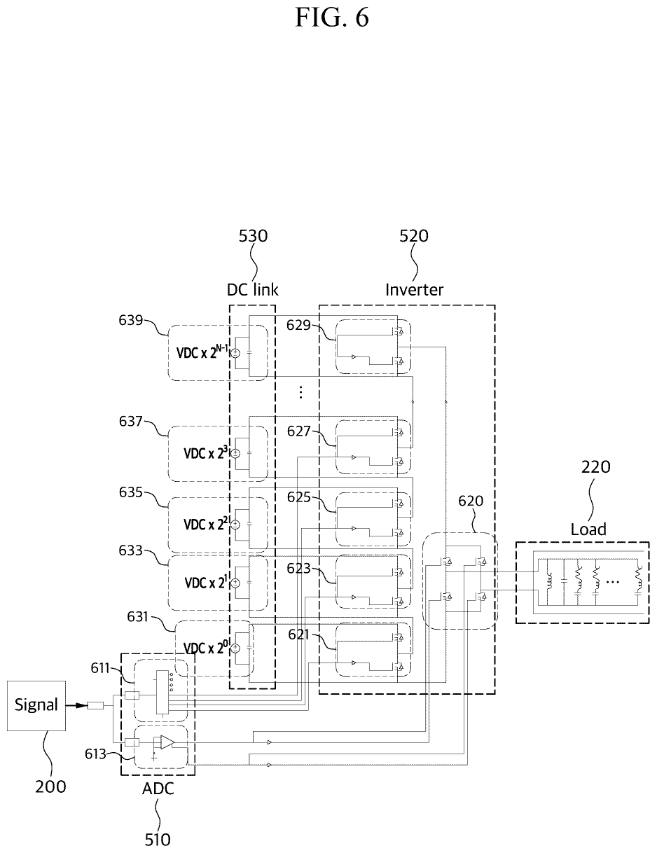

FIG. 6 is a circuit diagram of a power amplifier according to an example embodiment.

According to an example embodiment, the signal 200, which is received to the electronic apparatus 100, may be transferred to the ADC 510 of the power amplifier 500. The ADC 510 may include a first conversion part 611 and a second conversion part 613, each connected to the inverter 520. In the ADC 510, based on the first conversion part 611, an absolute value of the signal 200, in other words, a magnitude of the signal 200, may be converted to N binary bits corresponding to the magnitude of the signal 200 and transferred to the inverter 520. In addition, based on the second conversion part 613, a sign of the signal 200 may be converted to 1 binary bit corresponding to the sign of the signal 200 through a comparator and transferred to the inverter 520. Each of the first conversion part 611 and the second conversion part 613 may be connected to different locations of the inverter 520.

According to an example embodiment, the power amplifier 500 may include the DC link 530 that is connected to the inverter 520 and includes one or more DC voltage sources 631, 633, 635, 637, and 639. The number of one or more DC voltage sources 631, 633, 635, 637, and 639 may be determined as N corresponding to the N binary bits corresponding to the magnitude of the signal 200. As N increases, an amplified signal magnitude may be adjusted more precisely with higher resolution, and as a value of voltage direct current (VDC) increases, the signal 200 may be amplified higher.

According to an example embodiment, a voltage value of each DC voltage source included in one or more DC voltage sources 631, 633, 635, 637, and 639 may be set based on an exponential gap. For example, when a value of VDC is set to 100 volts (V) and a voltage value gap between each voltage source is set through the exponentiation of 2 in FIG. 6, a voltage value of the DC voltage source 631 may be set to 100 V, a voltage value of the DC voltage source 633 may be set to 200 V, a voltage value of the DC voltage source 635 may be set to 400 V, a voltage value of the DC voltage source 637 may be set to 800 V, and a voltage value of the DC voltage source 639 may be set to 1600 V.

According to an example embodiment, the inverter 520 may include one or more switching circuits 621, 623, 625, 627, and 629. Each switching circuit included in one or more switching circuits 621, 623, 625, 627, and 629 may be connected to each DC voltage source included in one or more DC voltage sources 631, 633, 635, 637, and 639, and each corresponding bit information may be transferred to each switching circuit from the first conversion part 611. In other words, when the N binary bits corresponding to the magnitude of the signal 200 are outputted from the first conversion part 611, each bit information included in the N bits may be transferred to each switching circuit to correspond to each switching circuit one by one. The electronic apparatus 100 may determine a sum value of voltage values of DC voltage sources connected to switching circuits, to which “1” is transferred as the bit information, as an amplified signal magnitude. For example, when the value of VDC is 100 V and the voltage value gap between each voltage source is set through the exponentiation of 2, if information on 5 binary bits transferred from the first conversion part 611 to the inverter 520 is 00101₍₂₎, the amplified signal magnitude may be 100 V+400 V=500 V.

According to an example embodiment, based on the amplified signal magnitude obtained through one or more switching circuits 621, 623, 625, 627, and 629 and information on the 1 binary bit corresponding to the sign of the signal 200 transferred from the second conversion part 613, the amplified signal 200 may be transferred to the load 220 through a circuit 620 of the inverter 520. In other words, the amplified signal magnitude identified through one or more switching circuits 621, 623, 625, 627, and 629 and the sign of the signal identified through the second conversion part 613 may be gathered in the circuit 620 and transferred to the load 220. The amplified signal 200 transferred to the load 220 may be transferred to the transducer 223.

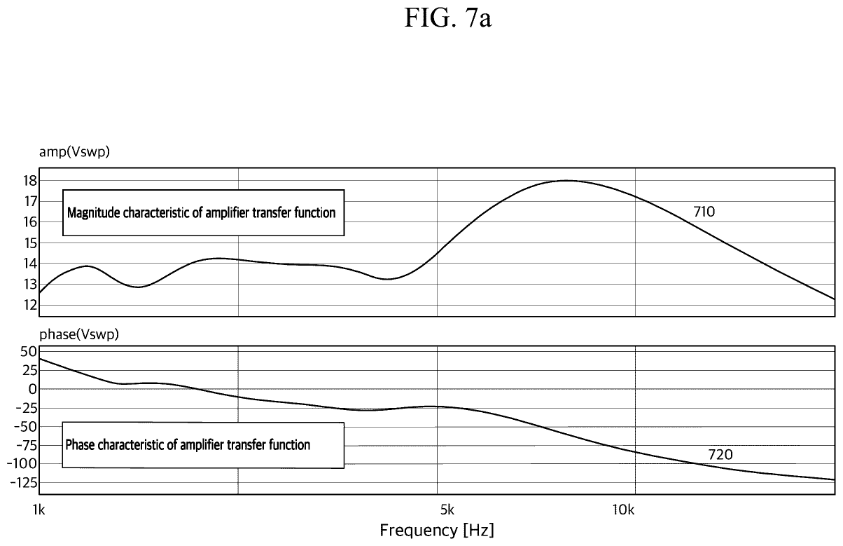

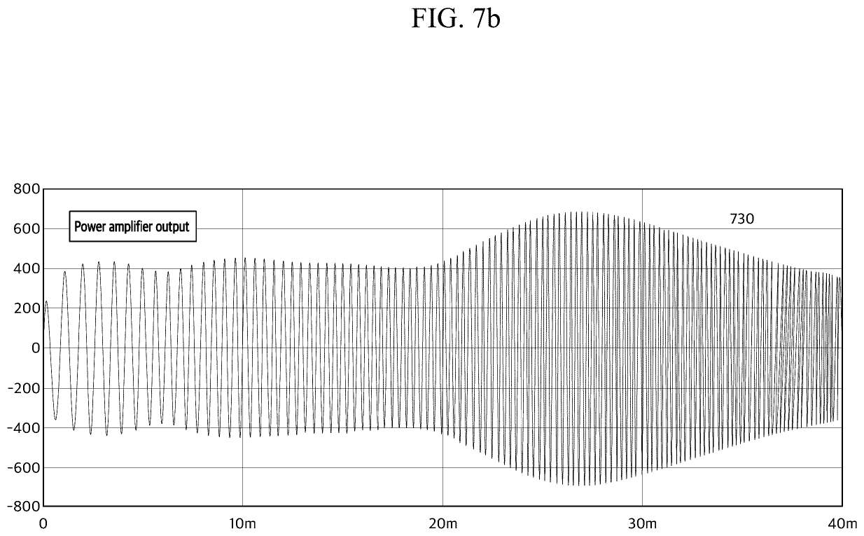

FIGS. 7A and 7B illustrate a signal transfer characteristic of an existing power amplifier.

Referring to FIG. 7A, a magnitude characteristic and a phase characteristic of a transfer function based on a frequency for the existing power amplifier 210 may be identified. Through a graph 710 indicating the magnitude characteristic of the transfer function based on the frequency and a graph 720 indicating the phase characteristic of the transfer function based on the frequency, the magnitude characteristic and the phase characteristic of the transfer function, which are distorted due to nonlinear device characteristics of the load 220 and the filter 215 and the transformer 217 within the power amplifier 210, may be identified. The x-axis and the y-axis of the graph 710 indicate a frequency (hertz (Hz)) of a logarithmic scale and a signal magnitude (decibel (dB)), respectively, and the x-axis and the y-axis of the graph 720 indicate the frequency (Hz) of the logarithmic scale and a phase (degree (°)), respectively. According to FIG. 7A, it may be identified that the magnitude and the phase of the transfer function are not constant according to a frequency change.

Referring to FIG. 7B, an output result of the existing power amplifier 210 may be identified. Through a graph 730 indicating a voltage output based on time, the output result of the power amplifier 210, not outputted in a constant manner due to nonlinear device characteristics of the load 220 and the filter 215 and the transformer 217 within the power amplifier 210, may be identified. The x-axis and the y-axis of the graph 730 indicate time (second (s)) and a voltage (V) outputted after amplified, respectively.

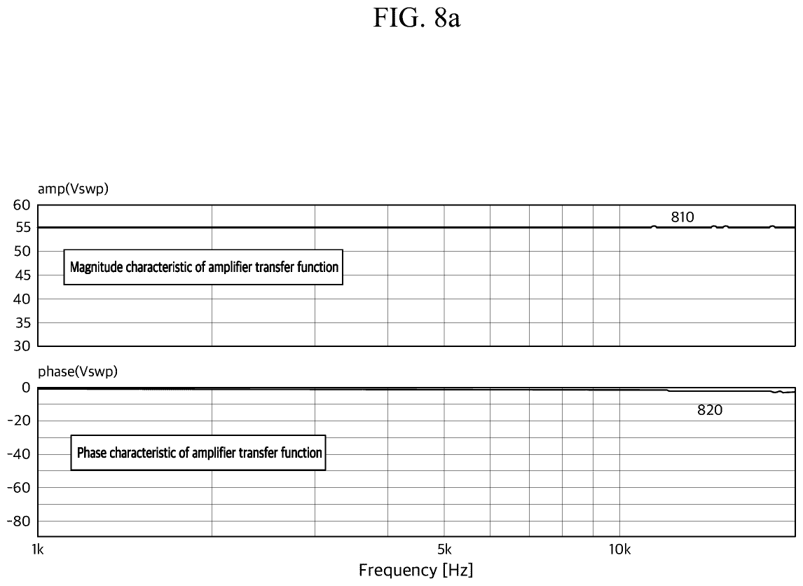

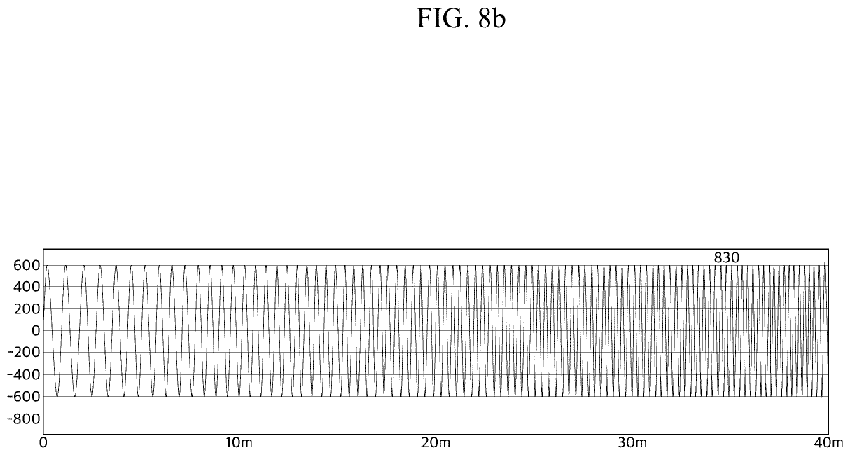

FIGS. 8A and 8B illustrate a signal transfer characteristic of a power amplifier according to an example embodiment of the present disclosure.

Referring to FIG. 8A, a magnitude characteristic and a phase characteristic of a transfer function based on a frequency for the power amplifier 500 according to an example embodiment may be identified. Through a graph 810 indicating the magnitude characteristic of the transfer function based on the frequency and a graph 820 indicating the phase characteristic of the transfer function based on the frequency, it may be identified that the magnitude characteristic and the phase characteristic of the transfer function for the power amplifier 500 are represented in a constant manner. Referring to the graph 820, it is identified that the phase characteristic of the transfer function decreases to a certain level as the frequency increases, and this characteristic may be understood as a level that may be improved when software processing is performed for the electronic apparatus 100 so that the phase characteristic of the transfer function is reflected. The x-axis and the y-axis of the graph 810 indicate a frequency (Hz) of a logarithmic scale and a signal magnitude (dB), respectively, and the x-axis and the y-axis of the graph 820 indicate the frequency (Hz) of the logarithmic scale and a phase (°), respectively.

Referring to FIG. 8B, an output result of the power amplifier 500 according to an example embodiment may be identified. Through a graph 830 indicating a voltage output based on time, a constant output result of the power amplifier 500 may be identified. The x-axis and the y-axis of the graph 830 indicate time(s) and a voltage (V) outputted after amplified, respectively.

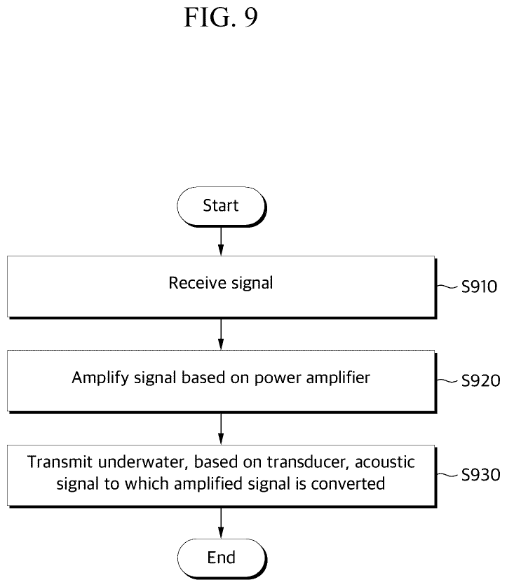

FIG. 9 illustrates a flowchart of a method of transmitting a signal by an electronic apparatus according to an example embodiment.

In operation S910, the electronic apparatus 100 may receive the signal 200. In operation S920, the electronic apparatus 100 may amplify the signal 200 based on the power amplifier 500. In operation S930, the electronic apparatus 100 may transmit underwater, based on the transducer 223, an acoustic signal to which the amplified signal 200 is converted. In FIG. 9, the power amplifier 500 of the electronic apparatus 100 may include the ADC 510, the inverter 520 connected to the ADC 510 and the load 220 including the transducer 223, and the DC link 530 connected to the inverter 520.

In an example embodiment according to FIG. 9, the ADC 510 may include the first conversion part 611 and the second conversion part 613, each connected to the inverter 520.

In an example embodiment according to FIG. 9, a magnitude of the signal 200 may be converted to a binary bit corresponding to the magnitude of the signal 200 based on the first conversion part 611 and transferred to the inverter 520, and a sign of the signal 200 may be converted to a binary bit corresponding to the sign of the signal 200 based on the second conversion part 613 and transferred to the inverter 520.

In an example embodiment according to FIG. 9, the DC link 530 may include one or more DC voltage sources 631 to 639, and a number of the one or more DC voltage sources 631 to 639 may be determined to correspond to a bit number of the binary bit corresponding to the magnitude of the signal 200.

In an example embodiment according to FIG. 9, a voltage value of each DC voltage source included in the one or more DC voltage sources 631 to 639 may be set based on an exponential gap.

In an example embodiment according to FIG. 9, the inverter 520 may include one or more switching circuits 621 to 629, and information on each bit of the binary bit corresponding to the magnitude of the signal 200 and information on a voltage of each DC voltage source included in the one or more DC voltage sources 631 to 639 may be transferred to each switching circuit included in the one or more switching circuits 621 to 629.

In an example embodiment according to FIG. 9, the magnitude of the signal 200 may be amplified based on the DC link 530 through the one or more switching circuits 621 to 629.

In an example embodiment according to FIG. 9, the amplified signal 200 may be obtained from the inverter 520 based on the amplified magnitude and information on the binary bit corresponding to the sign of the signal 200, and the amplified signal 200 may be transferred to the load 220 including the transducer 223.

In an example embodiment according to FIG. 9, the transducer 223 may include a sensor connected to a matching device 221 to which the amplified signal 200 is inputted and configured to convert the amplified signal 200 to the acoustic signal and transmit the acoustic signal.

As described above, according to the present disclosure, the electronic apparatus 100 may amplify the signal 200 without the filter 215 and the transformer 217, may have a constant transfer characteristic irrespective of features of the sensor included in the transducer 223, in other words, irrespective of the load 220, and may amplify higher or adjust more precisely a voltage based on the numbers of the DC link 530 and the switching circuits 621 to 629.

The electronic apparatus according to the above-described example embodiments may include a processor, a memory for storing and executing program data, a permanent storage such as a disk drive, a communication port that communicates with an external device, and a user interface device such as a touch panel, a key, and an icon. Methods implemented by software modules or algorithms may be stored in a computer-readable recording medium as computer-readable codes or program instructions executable on the processor. Here, the computer-readable recording medium includes a magnetic storage medium (for example, read-only memory (ROM), random-access memory (RAM), floppy disks, and hard disks) and an optically readable medium (for example, CD-ROM and digital versatile discs (DVDs)). The computer-readable recording medium may be distributed among network-connected computer systems, so that the computer-readable codes may be stored and executed in a distributed manner. The medium may be readable by a computer, stored in a memory, and executed on a processor.

Various example embodiments of the present disclosure may be represented by functional block elements and various processing steps. The functional blocks may be implemented in any number of hardware and/or software configurations that perform specific functions. For example, an example embodiment may adopt integrated circuit configurations, such as memory, processing, logic, and/or look-up table, which may execute various functions by the control of one or more microprocessors or other control devices. Similarly to that elements may be implemented as software programming or software elements, the example embodiments may be implemented in a programming or scripting language such as C, C++, Java, assembler, etc., including various algorithms implemented as a combination of data structures, processes, routines, or other programming constructs. Functional aspects may be implemented in an algorithm running on one or more processors. Further, the example embodiments may adopt the existing art for electronic environment setting, signal processing, and/or data processing. Terms such as “mechanism,” “element,” “means,” and “configuration” may be used broadly and are not limited to mechanical and physical configurations. The terms may include the meaning of a series of routines of software in association with a processor or the like.

It will be apparent to those skilled in the art that various modifications and variations can be made in the embodiments of the present invention without departing from the spirit or scope of the invention. Thus, it is intended that the present invention cover the modifications and variations of this invention provided they come within the scope of the appended claims and their equivalents.

What is claimed is:

1. A method of transmitting an acoustic signal in an underwater environment by an electronic apparatus, the method comprising:
receiving a signal;
amplifying the signal based on a power amplifier; and
transmitting underwater, based on a transducer, an acoustic signal to which the amplified signal is converted,
wherein the power amplifier comprises an analog to digital converter (ADC), an inverter connected to the ADC and to a load including the transducer, and a direct current (DC) link connected to the inverter.

2. The method of claim 1, wherein the ADC includes a first conversion part and a second conversion part, each connected to the inverter.

3. The method of claim 2, wherein a magnitude of the signal is converted to a binary bit corresponding to the magnitude of the signal based on the first conversion part and transferred to the inverter, and
wherein a sign of the signal is converted to a binary bit corresponding to the sign of the signal based on the second conversion part and transferred to the inverter.

4. The method of claim 3, wherein the DC link includes one or more DC voltage sources, and
wherein a number of the one or more DC voltage sources is determined to correspond to a bit number of the binary bit corresponding to the magnitude of the signal.

5. The method of claim 4, wherein a voltage value of each DC voltage source included in the one or more DC voltage sources is set based on an exponential gap.

6. The method of claim 4, wherein the inverter includes one or more switching circuits, and
wherein information on each bit of the binary bit corresponding to the magnitude of the signal and information on a voltage of each DC voltage source included in the one or more DC voltage sources is transferred to each switching circuit included in the one or more switching circuits.

7. The method of claim 6, wherein the magnitude of the signal is amplified based on the DC link through the one or more switching circuits.

8. The method of claim 7, wherein the amplified signal is obtained from the inverter based on the amplified magnitude and information on the binary bit corresponding to the sign of the signal, and
wherein the amplified signal is transferred to the load including the transducer.

9. The method of claim 1, wherein the transducer includes a sensor connected to a matching device to which the amplified signal is inputted and configured to convert the amplified signal to the acoustic signal and transmit the acoustic signal.

10. An electronic apparatus that performs a method of transmitting an acoustic signal in an underwater environment, the electronic apparatus comprising:
a processor; and
one or more memories configured to store one or more instructions,
wherein, when executed, the one or more instructions are configured to control the processor so that the processor performs:
receiving a signal;
amplifying the signal based on a power amplifier; and
transmitting underwater, based on a transducer, an acoustic signal to which the amplified signal is converted, and
wherein the power amplifier comprises an analog to digital converter (ADC), an inverter connected to the ADC and to a load including the transducer, and a direct current (DC) link connected to the inverter.
